(19) United States
(12) Patent Application Publication
(10) Pub. No.: US 2020/0141765 A1
(43) Pub. Date: May 7, 2020

(54) Magnetic Encoder and Apparatus Having the Same

(71) Applicant: HIWIN MIKROSYSTEM CORP., Taichung (TW)

(72) Inventors: Shuo-Wu Shih, Taichung (TW); Heng-Sheng HSIAO, Taichung (TW); Jen-Yuan CHANG, Taichung (TW)

(21) Appl. No.: 16/182,975

(22) Filed: Nov. 7, 2018

(51) Int. Cl. G01D 5/244

(52) U.S. Cl. CPC G01D 5/24476

(57) ABSTRACT

A magnetic encoder has an annular main body and a magnetic encoding unit. The main body is made of material with magnetic permeability, surrounds a central axis, and includes a first surface and a second surface opposite to said first surface. The magnetic encoding unit is disposed on one of the first surface and the second surface of the main body, and includes a plurality of first and second magnetic poles, each of which is annular and is centered at the central axis. The first and second magnetic poles are arranged in an alternating sequence.

### FIELD

The disclosure relates to a rotary encoder, and more particularly to a magnetic encoder.

### BACKGROUND

A conventional magnetic encoder disclosed in Taiwanese Patent No. I241063 is a thin, absolute encoder that measures angular position of a rotating shaft. The conventional magnetic encoder has a circular magnetic ring module, which consists of axially-magnetized and radially-magnetized rings, all of which are concentric.

The axially-magnetized and radially-magnetized rings are substantially arranged in an alternating sequence, forming a disk-shaped structure with the number of magnetic poles of each of the rings increases radially outwardly.

Through alternating arrangement of the axially-magnetized and radially-magnetized rings, the magnetic interference between two adjacent ones of the rings can be reduced, allowing the conventional magnetic encoder to be a structure with smaller size. However, when a position measurement requires two adjacent rings with the same orientation (both axially-magnetized or both radially-magnetized), a magnetic-shielding ring has to be placed therebetween for reducing interference between the magnetic fields of the two rings, which in turn increases the overall size. In addition, an Eddy-current sensor needs to be installed onto the conventional magnetic encoder for measurement of axial or radial runouts, as the conventional magnetic encoder is only able to obtain angular-position information of the shaft as an absolute encoder.

### SUMMARY

Therefore, an object of the disclosure is to provide a magnetic encoder that can alleviate the drawback of the prior art, and to provide a magnetic encoding apparatus having the same.

Accordingly, the magnetic encoder includes an annular main body and a magnetic encoding unit. The body is made of material with magnetic permeability, surrounds a central axis, and includes a first surface and a second surface opposite to the first surface.

The magnetic encoding unit is disposed on one of the first surface and the second surface of the main body, and includes a plurality of first and second magnetic poles. Each of the first and second magnetic poles is annular and is centered at the central axis. The first and second magnetic poles are arranged in an alternating sequence.

Another object of the disclosure is to provide a magnetic encoding apparatus adapted to be mounted to a rotating shaft for measuring runout thereof. The magnetic encoding apparatus has a magnetic encoder previously mentioned, which is adapted to surround and to be mounted to the rotating shaft, and a sensor that is spaced apart from the magnetic encoder. The sensor corresponds in position to the magnetic encoding unit of the magnetic encoder, and includes a magnetic-analog sensing member for sensing magnetic field strength of the magnetic encoding unit of the main body.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a first embodiment of a magnetic encoder according to the disclosure;

FIG. 2 is a fragmentary, enlarged top view of a magnetic encoding unit of the first embodiment;

FIG. 3 is a perspective view of a second embodiment of the magnetic encoder according to the disclosure;

FIG. 4 is a fragmentary, enlarged top view of the magnetic encoding unit of the second embodiment;

FIG. 5 is a perspective view of the first embodiment and a sensor being mounted to a rotating shaft;

FIG. 6 is a perspective view of the second embodiment and the sensor being mounted to the rotating shaft;

FIG. 7 is a perspective view of another configuration of the second embodiment and the sensor being mounted to the rotating shaft; and

FIG. 8 is a flow chart illustrating a process of a magnetic encoding apparatus measuring runout of the rotating shaft.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

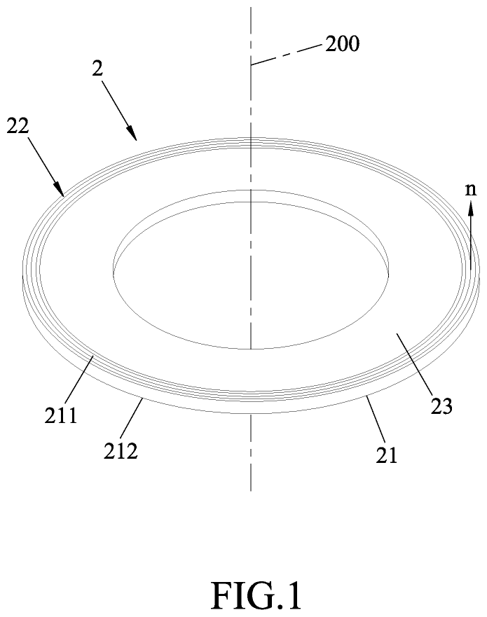

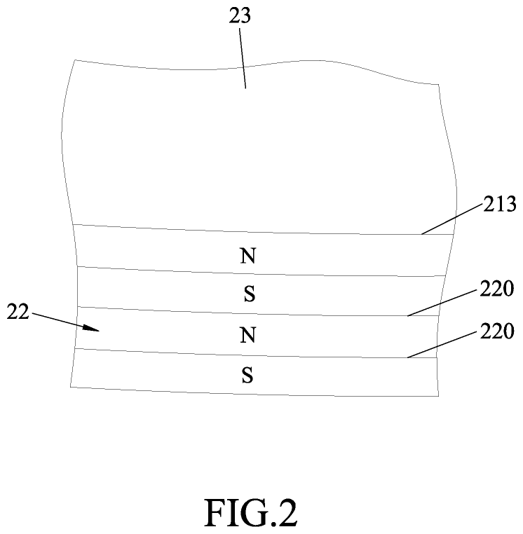

Referring to FIGS. 1 and 2, a first embodiment of a magnetic encoder 2 according to the disclosure has an annular main body 21 that surrounds a central axis 200, a magnetic encoding unit 22, and a fixing member 23. The main body 21 is made of material with magnetic permeability (e.g. metal, alloy), and includes a first surface 211 and a second surface 212 opposite to the first surface 211. The magnetic encoding unit 22 is disposed on the first surface 211, and includes a plurality of first and second magnetic poles (N, S), each of which is annular and is centered at the central axis 200 (i.e., each of the first and second magnetic poles (N, S) surrounds the central axis 200). In these embodiments, the first and second magnetic poles (N, S) are respectively north and south poles, but may be the opposite in other embodiments. Collectively, the first and second magnetic poles (N, S) are arranged in an alternating sequence.

Specifically, in the first embodiment, the main body 21 is flat and has shape of a disk that surrounds the central axis 200. In geometric terms, a normal (n) of each of the first and second surfaces 211, 212 of the main body 21 is parallel to the central axis 200. The main body 21 further includes an inner surrounding wall 213 that is proximate to the central axis 200. Junctions 220 of the first and second magnetic poles (N, S) of the magnetic encoding unit 22 are arranged in a radial direction of the main body 21. It should be noted that, while there are two first magnetic poles (N) and two second magnetic poles (S) shown in this embodiment, the total number of magnetic poles may vary in other embodiments.

The fixing member 23 is mounted to the inner surrounding wall 213 of the main body 21, so that the main body 21 may be mounted to another apparatus easily. In should be noted that, as long as the main body 21 can be mounted to the apparatus, the fixing member 23 may be made of any shape, or may be omitted.

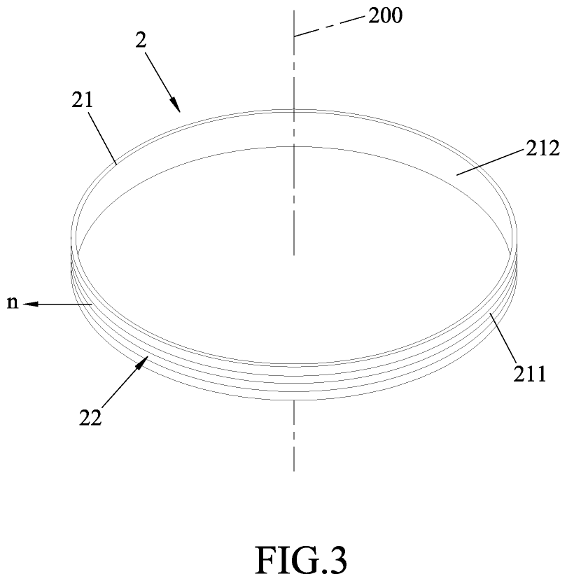

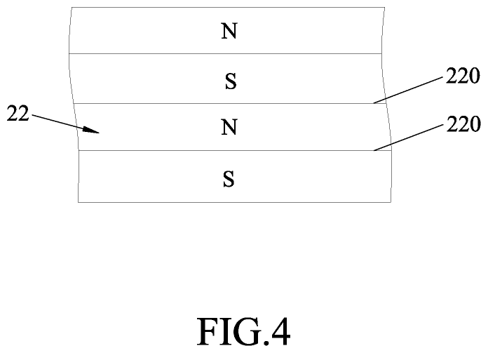

Referring to FIGS. 3 and 4, a second embodiment of the magnetic encoder 2 according to the disclosure is similar to the first embodiment, with the following differences. Notably, the main body 21 has shape of a tube that surrounds the central axis 200. In geometric terms, a normal (n) of each of the first and second surfaces 211, 212 is perpendicular to the central axis 200, with the second surface 212 facing the central axis 200, such that the magnetic encoding unit 22 disposed on the first surface 211 faces outward. In this embodiment, the junctions 220 of the first and second magnetic poles (N, S) are arranged along the central axis 200, and the fixing member 23 is mounted to the second surface 212 of the main body 21.

Through the alternating arrangement of the annular first and second magnetic poles (N, S), the magnetic encoder 2 can measure the radial and axial runout of a rotating shaft. To be more specific, a magnetic line of force extends from the normal (n) of the first magnetic pole (N) and into the second magnetic pole (S). The magnetizing direction of magnetic poles of the first embodiment is parallel to the direction of the central axis 200, and the magnetizing direction of magnetic poles of the second embodiment is perpendicular to the direction the central axis 200. To further elaborate how both embodiments achieve the runout measurement of the rotating shaft, a magnetic encoding apparatus is utilized.

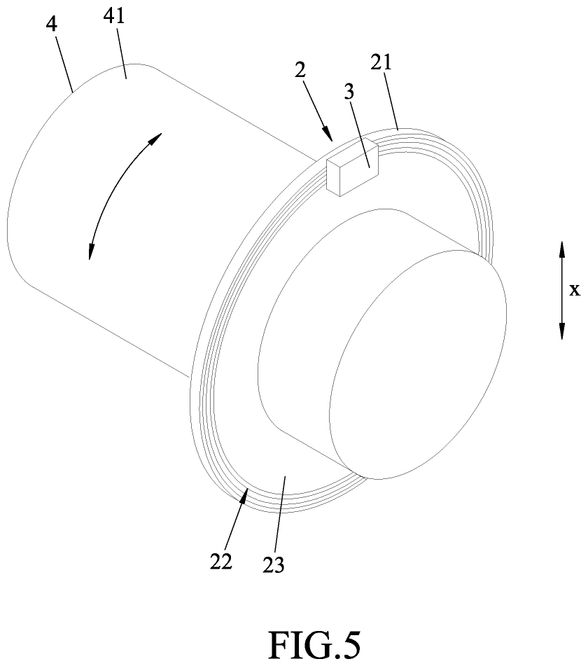

Referring to FIGS. 5 to 7, the magnetic encoding apparatus is adapted to be mounted to a rotating shaft 4 for measuring runout thereof, and includes the magnetic encoder 2 that is adapted to surround and to be co-rotatably mounted to the rotating shaft 4, and a sensor 3 that is spaced apart from the magnetic encoder 2 and that corresponds in position to the magnetic encoding unit 22 of the magnetic encoder 2.

Referring specifically to FIG. 5, during an assembling process of the magnetic encoding apparatus, when the magnetic encoder 2 of the first embodiment is mounted to the rotating shaft 4, the fixing member 23 connects the main body 21 with the rotating shaft 4, with the inner surrounding wall 213 of the main body 21 of the magnetic encoder 2 facing the rotating shaft 4. Meanwhile, the sensor 3 is mounted to a fixed position in proximity to the magnetic encoding unit 22. As long as the sensor 3 is spaced apart from the magnetic encoding unit 22, the configuration of the sensor 3 may be different in other embodiments. In addition, the sensor 3 is configured as a magnetic sensor such as magnetic reluctance or Hall Effect sensor, and is not limited to such.

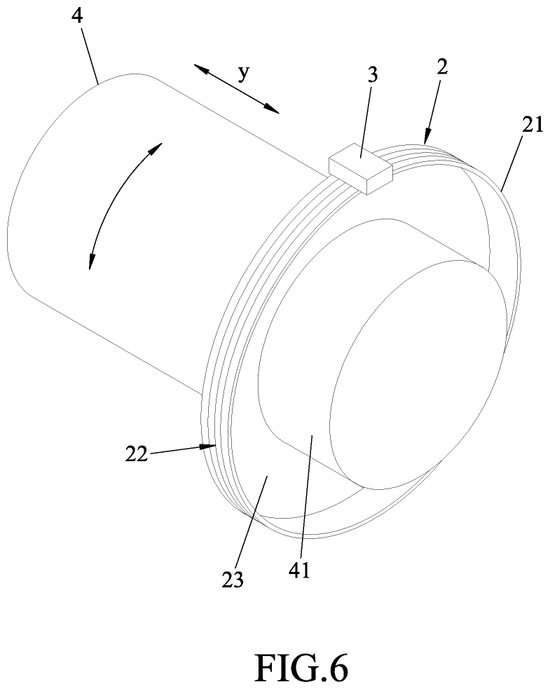

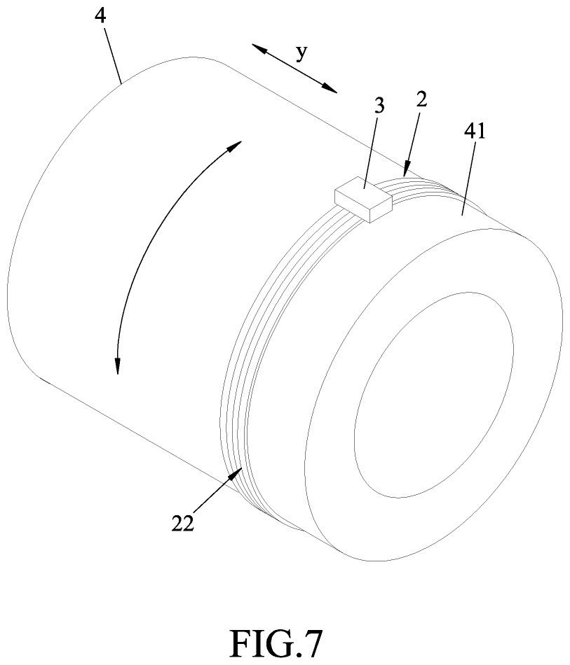

Referring back to FIG. 6, during another assembling process of the magnetic encoding apparatus, when the magnetic encoder 2 of the second embodiment is mounted to the rotating shaft 4, the fixing member 23 connects the main body 21 with the rotating shaft 4, with the second surface 212 of the main body 21 of the magnetic encoder 2 facing the rotating shaft 4, such that the magnetic encoding unit 22 faces away from exterior 41 of the rotating shaft 4. Similar to the previous assembly, the sensor 3 in this assembly is also spaced apart from the magnetic encoding unit 22. In addition, referring back to FIG. 7, the magnetic encoder 2 may also be mounted to the rotating shaft 4 directly without a fixing member 23, as the second surface 212 of the main body 21 is adapted to be in direct contact with the exterior 41 of the rotating shaft 4.

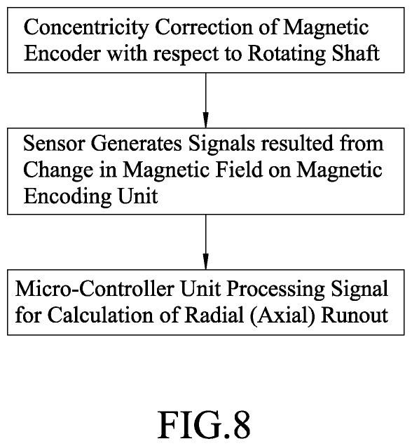

FIG. 8 is presented, alongside FIGS. 5 to 7, to further elaborate the measuring processes of the magnetic encoding apparatus. Initially, a concentricity correction is implemented, ensuring that the magnetic encoder 2 and the rotating shaft 4 are concentric with each other.

Next, during a rotational movement of the rotating shaft 4, if the magnetic encoding apparatus with the magnetic encoder 2 of the first embodiment is mounted to the rotating shaft 4, the sensor 3 generates voltage signal resulted from change in the magnetic field on the magnetic encoding unit 22 due to movement in a radial direction (X, FIG. 5) of the rotating shaft 4. Then, a micro-controller unit (MCU, not shown) in the sensor 3 processes the voltage signal to calculate value of the radial runout of the rotating shaft 4. On the other hand, if the magnetic encoding apparatus with the magnetic encoder 2 of the second embodiment is mounted to the rotating shaft 4, the sensor 3 senses the voltage signal generated from change of the magnetic field on the magnetic encoding unit 22 due to movement in an axial direction (y, FIGS. 6 and 7) of the rotating shaft 4 instead, and the MCU processes the voltage signal to calculate value of the axial runout of the rotating shaft 4.

Overall, the magnetic encoder 2 of the disclosure is capable of maintaining a compact structure, with the shape of a disk or a tube. By implementing alternating arrangement of the first and second magnetic poles (N, S) in the magnetic encoding unit 22, the magnetic encoder 2 of the disclosure does not require magnetic-shielding ring to block interference between magnetic fields generated by the respective magnetic poles.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A magnetic encoder comprising:
an annular main body that is made of material with magnetic permeability, that surrounds a central axis, and that includes a first surface and a second surface opposite to said first surface; and
a magnetic encoding unit that is disposed on one of said first surface and said second surface of said main body, and that includes a plurality of first and second magnetic poles, each of said first and second magnetic poles being annular and being centered at the central axis, said first and second magnetic poles being arranged in an alternating sequence.

2. The magnetic encoder as claimed in claim 1, wherein:
a normal of each of said first and second surfaces is parallel to the central axis;
said magnetic encoding unit is disposed on said first surface; and
junctions of said first and second magnetic poles are arranged in a radial direction of said main body.

3. The magnetic encoder as claimed in claim 2, further comprising a fixing member that is mounted to an inner surrounding wall of said main body.

4. The magnetic encoder as claimed in claim 1, wherein:
a normal of each of said first and second surfaces is perpendicular to the central axis;
said second surface faces the central axis;
said magnetic encoding unit is disposed on said first surface; and
junctions of said first and second magnetic poles are arranged along the central axis.

5. The magnetic encoder as claimed in claim 4, further comprising a fixing member that is mounted to said second surface of said main body.

6. The magnetic encoder as claimed in claim 1, wherein said first and second magnetic poles are respectively north and south poles.

7. A magnetic encoding apparatus adapted to be mounted to a rotating shaft for measuring runout thereof, said magnetic encoding apparatus comprising:
a magnetic encoder of claim 1 that is adapted to surround and to be mounted to the rotating shaft; and
a sensor that is spaced apart from said magnetic encoder and that corresponds in position to said magnetic encoding unit of said magnetic encoder.

8. The magnetic encoding apparatus as claimed in claim 7, wherein a normal of each of said first and second surfaces is parallel to the central axis, and an inner surrounding wall of said main body faces the rotating shaft.

9. The magnetic encoding apparatus as claimed in claim 7, wherein a normal of each of said first and second surfaces is perpendicular to the central axis, and said second surface of said main body faces the rotating shaft.

10. The magnetic encoding apparatus as claimed in claim 7, wherein said magnetic encoder further includes a fixing member via which said main body is connected to the rotating shaft.

11. The magnetic encoding apparatus as claimed in claim 9, wherein said second surface of said main body is adapted to be in direct contact with an exterior of the rotating shaft.
